(19) United States
(12) Patent Application Publication
(10) Pub. No.: US 2019/0058835 A1
(43) Pub. Date: Feb. 21, 2019

(54) IMAGING DEVICE

(71) Applicant: KABUSHIKI KAISHA TOKAI-RIKA-DENKI-SEISAKUSHO, Aichi (JP)

(72) Inventors: Tomonori ICHIKAWA, Aichi (JP); Toshinari NAKAI, Aichi (JP)

(73) Assignee: KABUSHIKI KAISHA TOKAI-RIKA-DENKI-SEISAKUSHO, Aichi (JP)

(21) Appl. No.: 16/080,842

(22) PCT Filed: Mar. 2, 2017
(86) PCT No.: PCT/JP2017/008367

§ 371 Date: Aug. 29, 2018

(30) Foreign Application Priority Data
Mar. 7, 2016 (JP) 2016-043502

(51) Int. Cl. H04N 5/247; G03B 17/08; B60R 1/00; H04N 5/225

(52) U.S. Cl. CPC H04N 5/247; H04N 5/2252; B60R 1/00; G03B 17/08

(57) ABSTRACT

An imaging device in which, a main camera is connected to a control substrate by a flexible substrate, and a sub camera is connected to the control substrate by a sensor connector and a control connector. The control substrate is attached to the sub camera by being fastened together using screws, and the control substrate is detached from the sub camera by unfastening the screws fastening the control substrate to the sub camera. This enables the number of cameras to be easily changed.

### TECHNICAL FIELD

The present invention relates to an imaging device including plural imaging mechanisms provided to a vehicle.

### BACKGROUND ART

In a vehicular side camera device described in Japanese Patent Application Laid-Open (JP-A) No. 2014-231334, a camera is housed between a bracket member and a cover member.

Note that in a hypothetical case in which a pair of cameras were provided and a control substrate of one camera was provided to the other camera in this vehicular side camera device, the ability to change the number of cameras easily would be desirable.

### SUMMARY OF INVENTION

### Technical Problem

In consideration of the above circumstances, an object of the present invention is to obtain an imaging device in which the number of imaging mechanisms can be easily changed.

### Solution to Problem

An imaging device of a first aspect of the present invention includes plural imaging mechanisms that are provided to a vehicle and that are configured to perform imaging, and a control device that is attached to one of the imaging mechanism, that is electrically connected to another of the imaging mechanism so as to control the other of the imaging mechanism, and that is detachable from the one of the imaging mechanism.

An imaging device of a second aspect of the present invention is the imaging device of the first aspect of the present invention, wherein the control device is attachable to plural of the imaging mechanisms.

An imaging device of a third aspect of the present invention is the imaging device of the first aspect or the second aspect of the present invention, wherein the control device controls plural of the imaging mechanisms.

An imaging device of a fourth aspect of the present invention is the imaging device of any one of the first aspect to the third aspect of the present invention, further including an operating device that is provided to each of the plural imaging mechanisms and that is electrically operated such that the imaging mechanism performs imaging, and a housing body that houses plural of the operating devices and that restricts water ingress into the plural operating devices.

An imaging device of a fifth aspect of the present invention is the imaging device of any one of the first aspect to the fourth aspect of the present invention, further including a connecter that is flexible and that electrically connects plural of the imaging mechanisms.

### Advantageous Effects of Invention

In the imaging device of the first aspect of the present invention, the plural imaging mechanisms are provided to the vehicle, and the plural imaging mechanisms are configured to perform imaging. The control device is attached to the one of the imaging mechanism. The control device is electrically connected to the other of the imaging mechanism and controls the other of the imaging mechanism.

Note that the control device is detachable from the one of the imaging mechanism. This enables the number of imaging mechanisms to be easily changed.

In the imaging device of the second aspect of the present invention, the control device is attachable to plural imaging mechanisms. This enables the control device that has been detached from one imaging mechanism to be attached to an imaging mechanism other than the one imaging mechanism.

In the imaging device of the third aspect of the present invention, the control device controls the plural imaging mechanisms. This enables the number of control device to be reduced.

In the imaging device of the fourth aspect of the present invention, the operating device is provided to each of the plural imaging mechanisms. The operating device is electrically operated such that the imaging mechanism performs imaging.

Note that the plural operating devices are housed in the housing body, and that the housing body restricts water ingress to the plural operating devices. This obviates the need to provide a separate housing body for each operating device.

In the imaging device of the fifth aspect of the present invention, the plural imaging mechanisms are electrically connected by the connecter.

Note that the connecter is flexible. This enables damage to the connecter to be suppressed, even in cases in which load is input to the connecter due to the relative positions of the plural imaging mechanisms.

### BRIEF DESCRIPTION OF DRAWINGS

FIG. 1 is a side view illustrating an imaging device according to a first exemplary embodiment of the present invention, as viewed from one vehicle width direction side.

FIG. 2 is a face-on view illustrating the imaging device according to the first exemplary embodiment of the present invention, as viewed from the vehicle rear.

FIG. 3 is a side view illustrating a partially assembled state of the imaging device according to the first exemplary embodiment of the present invention, as viewed from the one vehicle width direction.

FIG. 4A is a plan view illustrating a state in which a flexible substrate and so on are laid out flat in the imaging device according to the first exemplary embodiment of the present invention.

FIG. 4B is a side view illustrating the state in which the flexible substrate and so on are laid out flat in the imaging device according to the first exemplary embodiment of the present invention.

FIG. 5A is a plan view illustrating an assembled state of the flexible substrate and so on of the imaging device according to the first exemplary embodiment of the present invention, as viewed from above.

FIG. 5B is a side view illustrating the assembled state of the flexible substrate and so on of the imaging device according to the first exemplary embodiment of the present invention, as viewed from another vehicle width direction side.

FIG. 6 is a side view illustrating an imaging device with a specification that does not include a sub camera, as viewed from the one vehicle width direction side.

FIG. 7A is a plan view illustrating a state in which a flexible substrate and so on are laid out flat in an imaging device according to a second exemplary embodiment of the present invention.

FIG. 7B is a side view illustrating the state in which the flexible substrate and so on are laid out flat in the imaging device according to the second exemplary embodiment of the present invention.

FIG. 8A is a plan view illustrating a partially assembled state of the flexible substrate and so on of the imaging device according to the second exemplary embodiment of the present invention, as viewed from above.

FIG. 8B is a side view illustrating the partially assembled state of the flexible substrate and so on of the imaging device according to the second exemplary embodiment of the present invention, as viewed from the other vehicle width direction.

FIG. 9A is a plan view illustrating an assembled state of the flexible substrate and so on of the imaging device according to the second exemplary embodiment of the present invention, as viewed from above.

FIG. 9B is a side view illustrating the assembled state of the flexible substrate and so on of the imaging device according to the second exemplary embodiment of the present invention, as viewed from the other vehicle width direction.

### DESCRIPTION OF EMBODIMENTS

### First Exemplary Embodiment

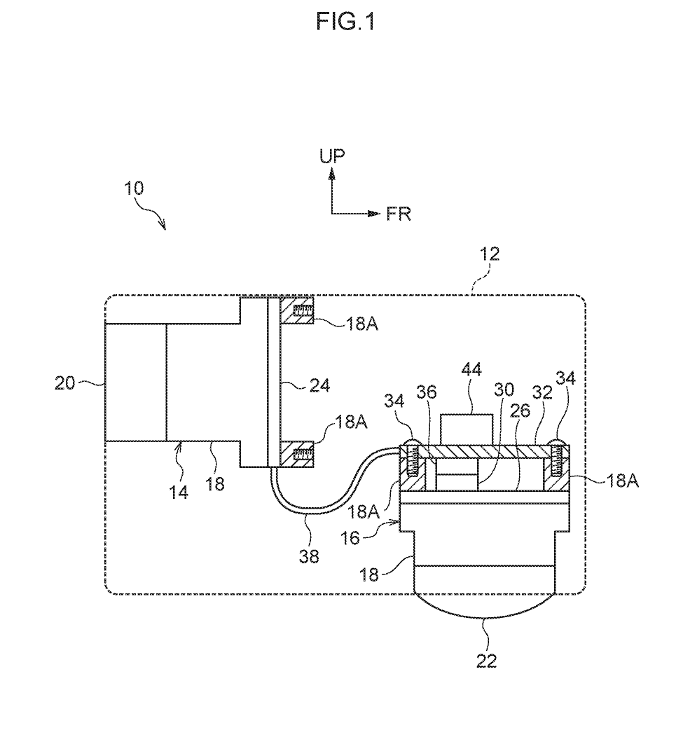

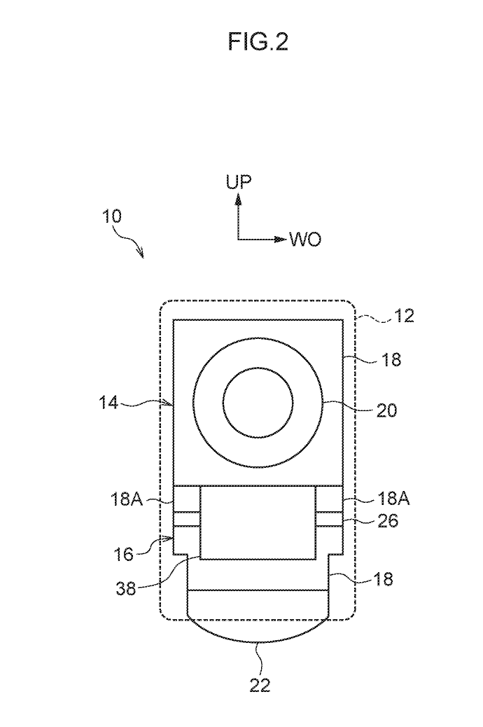

FIG. 1 is a side view illustrating an imaging device 10 according to a first exemplary embodiment of the present invention as viewed from one vehicle width direction side, and FIG. 2 is a face-on view illustrating the imaging device 10 as viewed from the vehicle rear. Note that in the drawings, the arrow FR indicates toward the vehicle front, the arrow WO indicates toward the one vehicle width direction side, and the arrow UP indicates upward.

The imaging device 10 according to the present exemplary embodiment is mounted to the outer side of a vehicle front side end of an up-down direction intermediate section of a vehicle side door (a front side door, a vehicle body).

As illustrated in FIG. 1 and FIG. 2, the imaging device 10 includes a substantially rectangular box shaped housing case 12, serving as a housing body. The housing case 12 restricts water ingress into its interior.

A main camera 14 (first imaging mechanism) and a sub camera 16 (second imaging mechanism), each serving as an imaging mechanism, are housed inside the housing case 12. The main camera 14 and the sub camera 16 are fixed to the interior of the housing case 12. The main camera 14 is disposed at the vehicle upper rear side of the sub camera 16, and leading ends of the main camera 14 and the sub camera 16 respectively face the vehicle rear and downward.

A holder 18, serving as a retainer, is provided to both the main camera 14 and the sub camera 16. A main lens 20 (first lens portion) and a sub lens 22 (second lens portion), serving as lens portions, are respectively provided to the main camera 14 and to the sub camera 16 at a leading end of the respective holder 18. Optical axes (central axial lines) of the main lens 20 and the sub lens 22 are respectively oriented toward the vehicle rear and downward, and the optical axes of the main lens 20 and the sub lens 22 are disposed so as to be coplanar in a plane perpendicular to the vehicle width direction. Surfaces of the main lens 20 and the sub lens 22 are exposed to the housing case 12 exterior. Sealing is performed between the main lens 20, the sub lens 22, and peripheral walls of the housing case 12 so as to restrict water ingress into the housing case 12 interior.

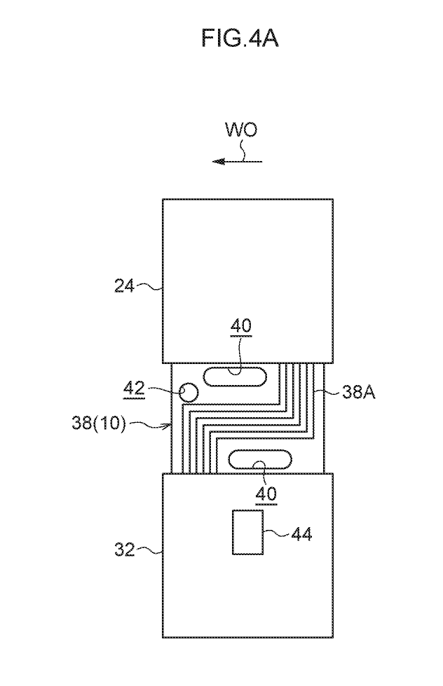

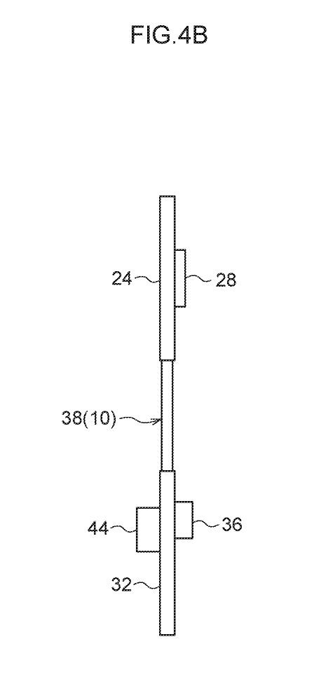

A main sensor substrate 24 (first operating device, see FIG. 4A and FIG. 4B) and a sub sensor substrate 26 (second operating device), each having a flat plate shape and serving as an operating device, are respectively provided to the main camera 14 and the sub camera 16 at a base end side of the respective holder 18. The main sensor substrate 24 and the sub sensor substrate 26 are disposed so as to be perpendicular to the optical axes of the respective main lens 20 and sub lens 22. An imaging element 28 (image sensor, see FIG. 4B) is provided on a front face of both the main sensor substrate 24 and the sub sensor substrate 26. A sensor connector 30, serving as a first connector configuring a second connecter, is provided on a back face of the sub sensor substrate 26.

A specific number of (such as two) column shaped attachment portions 18A are provided at a base end portion of both the main camera 14 and the sub camera 16. Each attachment portion 18A projects out from the respective holder 18 further toward the base end side of the holder 18 than the respective main sensor substrate 24 or sub sensor substrate 26.

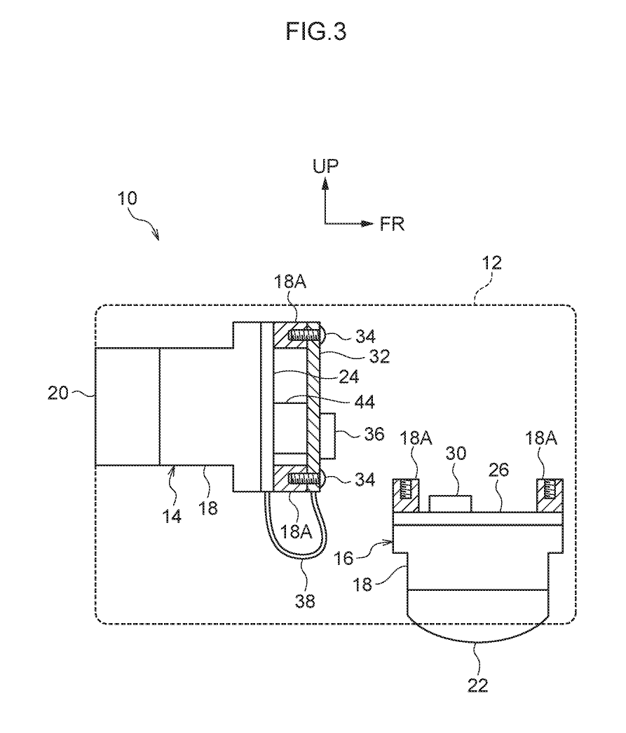

A flat plate shaped control substrate 32 (see FIG. 4A and FIG. 4B), serving as a control device, is attached by being fastened using screws 34 to the attachment portions 18A of the sub camera 16. The control substrate 32 is disposed so as to be perpendicular to the optical axis of the sub lens 22. The control substrate 32 is detachable from the attachment portions 18A of the sub camera 16 by unfastening the screws 34, and the control substrate 32 is attachable to the attachment portions 18A of the main camera 14 by being fastened using screws 34 (see FIG. 3). A control connector 36, serving as a second connector configuring the second connecter, is provided to a front face of the control substrate 32. The control connector 36 is connected to the sensor connector 30 of the sub sensor substrate 26. The control substrate 32 is electrically connected to the sub sensor substrate 26 through the control connector 36 and the sensor connector 30. Detaching the control substrate 32 from the attachment portions 18A of the sub camera 16 disconnects the connection between the control connector 36 and the sensor connector 30, and thereby disconnects the electrical connection between the control substrate 32 and the sub sensor substrate 26.

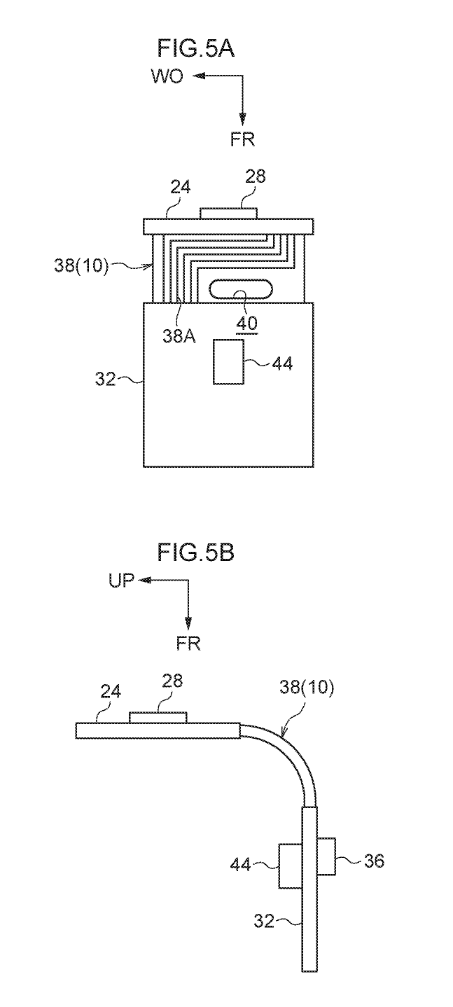

The control substrate 32, and the main sensor substrate 24 of the main camera 14, are connected by a belt shaped flexible substrate 38 (see FIG. 4A and FIG. 4B), serving as a connecter (first connecter). The flexible substrate 38 extends between the control substrate 32 and the main sensor substrate 24. A specific number of wires 38A are provided to the flexible substrate 38. The flexible substrate 38 electrically connects the control substrate 32 and the main sensor substrate 24 together through the wires 38A, and cannot disconnect the electrical connection between the control substrate 32 and the main sensor substrate 24. The flexible substrate 38 is flexible and capable of curving and bending. The flexible substrate 38 is curved in its extension direction (see FIG. 5A and FIG. 5B).

One length direction side portion (a control substrate 32-side portion) of the wires 38A extends along the extension direction of the flexible substrate 38 at one extension width direction end portion (one vehicle width direction-side end portion) of the flexible substrate 38, and another length direction side portion (a main sensor substrate 24-side portion) of the wires 38A extends along the extension direction of the flexible substrate 38 at another extension width direction end portion (another vehicle width direction-side end portion) of the flexible substrate 38. A length direction intermediate portion of the wires 38A extends along an extension width direction of the flexible substrate 38 (the vehicle width direction).

Elongated, substantially elliptical shaped perforation holes 40, serving as cut portions, are formed penetrating a control substrate 32-side end portion and a main sensor substrate 24-side end portion of the flexible substrate 38. The control substrate 32-side perforation hole 40 and the main sensor substrate 24-side perforation hole 40 respectively extend toward another extension width direction side and one extension width direction side from an extension width direction center portion of the flexible substrate 38. Portions of the pair of perforation holes 40 at central side in the flexible substrate 38 extension width direction oppose each other in the extension direction of the flexible substrate 38.

A circular shaped fixing hole 42, serving as a fixing portion, is formed penetrating the main sensor substrate 24-side end portion (or alternatively the control substrate 32-side end portion) of the flexible substrate 38. The fixing hole 42 is disposed at a portion other than the extension width direction center portion of the flexible substrate 38.

A connector 44 is provided on a back face of the control substrate 32. The control substrate 32 is electrically connected to an onboard controller (not illustrated in the drawings) through the connector 44. Thus, the main sensor substrate 24 is electrically operated under control of the control substrate 32, and the main camera 14 (the imaging element 28 of the main sensor substrate 24) captures images looking toward the vehicle rear using the main lens 20. The sub sensor substrate 26 is also electrically operated under control of the control substrate 32, and the sub camera 16 (the imaging element 28 of the sub sensor substrate 26) captures images looking downward using the sub lens 22. The main sensor substrate 24 can be electrically operated under control of the control substrate 32 even when the electrical connection between the control substrate 32 and the sub sensor substrate 26 has been disconnected.

A monitor (not illustrated in the drawings), serving as a display unit, is electrically connected to the controller. Images captured by the main camera 14 and the sub camera 16 are displayed on the monitor under control of the controller. The monitor is disposed inside a vehicle cabin, and a vehicle occupant checks images (images captured by the main camera 14 and the sub camera 16) displayed on the monitor, thereby assisting the occupant with visibility at the vehicle rear side and lower side.

Explanation follows regarding operation of the present exemplary embodiment.

When assembling the imaging device 10 with the above configuration, in a state illustrated in FIG. 3 in which the control substrate 32 is attached to the attachment portions 18A of the main camera 14 by being fastened together using the screws 34 (or any state in which the control substrate 32 is temporarily fixed to the main camera 14), the main camera 14 (including the control substrate 32 and the flexible substrate 38) is assembled to the housing case 12 interior, and the sub camera 16 is also assembled to the housing case 12 interior. The control substrate 32 is then detached from the attachment portions 18A of the main camera 14, after which the control substrate 32 is attached to the attachment portions 18A of the sub camera 16 by being fastened together using the screws 34, and the control connector 36 of the control substrate 32 and the sensor connector 30 of the sub sensor substrate 26 are connected together.

Note that in the imaging device 10, the control substrate 32 is attached by being fastened using the screws 34 to the sub camera 16 (attachment portions 18A). By unfastening the control substrate 32 from the sub camera 16 using the screws 34, the control substrate 32 is detached from the sub camera 16, and the electrical connection between the control substrate 32 and the sub sensor substrate 26 through the control connector 36 and the sensor connector 30 is disconnected.

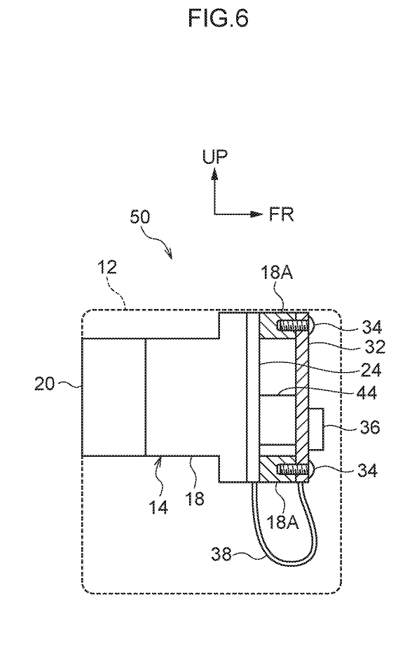

This enables the sub camera 16 to be easily separated from the main camera 14 and the control substrate 32, and the number of cameras (main camera 14 and sub camera 16) to be easily changed. This enables common application of the main camera 14, the control substrate 32, and the flexible substrate 38 to the imaging device 10 with a specification including the sub camera 16, and to an imaging device 50 (see FIG. 6) with a specification that does not include the sub camera 16, thereby enabling costs to be reduced.

The control substrate 32 is attachable either to the main camera 14 (attachment portions 18A) or to the sub camera 16 (attachment portions 18A). Thus, when assembling the imaging device 10 as described above, the main camera 14 with the control substrate 32 attached can be assembled to the housing case 12 interior, and the sub camera 16 can also be assembled to the housing case 12 interior. This enables the main camera 14 and the sub camera 16 to be easily assembled to the housing case 12 interior even when extension direction dimensions of the flexible substrate 38 are small, in contrast to cases in which the sub camera 16 with the control substrate 32 attached is assembled to the housing case 12 interior, and the main camera 14 is assembled to the housing case 12 interior. This enables the imaging device 10 to be easily assembled. Moreover, the control substrate 32 can be attached to the main camera 14 in the imaging device 50 (see FIG. 6) with a specification that does not include the sub camera 16.

The control substrate 32 controls the main camera 14 (main sensor substrate 24) and the sub camera 16 (sub sensor substrate 26). This obviates the need to provide separate control substrates 32 for the main camera 14 and the sub camera 16, enabling the number of control substrates 32 to be reduced, the imaging device 10 to be made smaller in size, and costs to be reduced.

The main camera 14 (including the main sensor substrate 24) and the sub camera 16 (including the sub sensor substrate 26) are housed inside the housing case 12, and the housing case 12 restricts water ingress to the main sensor substrate 24 and the sub sensor substrate 26. This obviates the need to provide separate housing cases 12 for the main camera 14 (including the main sensor substrate 24) and the sub camera 16 (including the sub sensor substrate 26), enabling the imaging device 10 to be made smaller in size in the vehicle front-rear direction in particular, and costs to be reduced.

The control substrate 32 and the flexible substrate 38 are also housed inside the housing case 12, and the housing case 12 restricts water ingress to the control substrate 32 and the flexible substrate 38. This obviates the need to provide separate housing cases 12 for the control substrate 32 and the flexible substrate 38, enabling the imaging device 10 to be made smaller in size in the vehicle front-rear direction in particular, and costs to be reduced.

The flexible substrate 38 is flexible. In the present exemplary embodiment, the flexible substrate 38 is thereby made to curve in the extension direction of the flexible substrate 38 so as to correspond to relative positions of the main camera 14 (main sensor substrate 24) and the sub camera 16 (sub sensor substrate 26), enabling the imaging device 10 to be made smaller in size in the vehicle front-rear direction and up-down direction in particular.

### Second Exemplary Embodiment

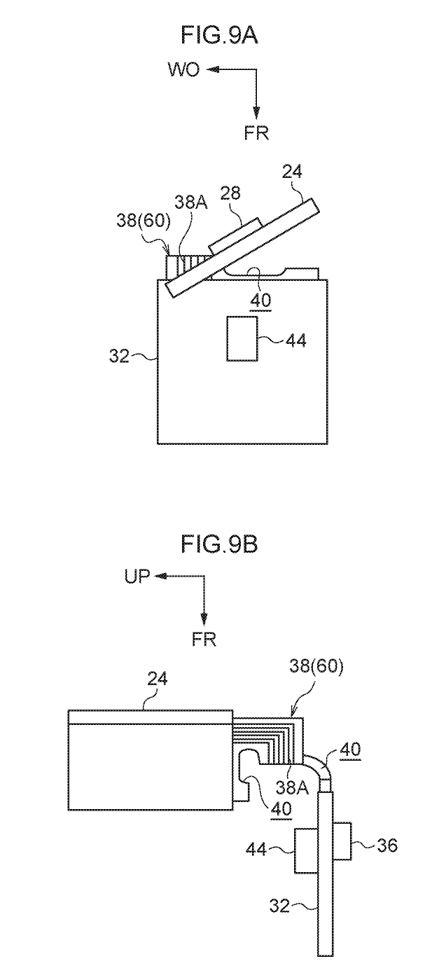

FIG. 9A is a plan view illustrating an assembled state of the flexible substrate 38 and so on of an imaging device 60 according to a second exemplary embodiment of the present invention, as viewed from above. FIG. 9B is a side view illustrating the assembled state of the flexible substrate 38 and so on of the imaging device 60, as viewed from the other vehicle width direction side.

The imaging device 60 according to the present exemplary embodiment has substantially the same configuration as the first exemplary embodiment, but differs in the following points.

In the imaging device 60 according to the present exemplary embodiment, the optical axis of the main lens 20 of the main camera 14 is oriented toward one vehicle width direction side (the vehicle width direction outside, for example) on progression toward the vehicle rear, such that the optical axes of the main lens 20 and the sub lens 22 are not disposed in the same plane. Thus, as illustrated in FIG. 9A and FIG. 9B, the front face of the main sensor substrate 24 faces toward the one vehicle width direction side on progression toward the vehicle rear, and the orientations of the front face of the main sensor substrate 24 and the front face of the control substrate 32 are not disposed in the same plane.

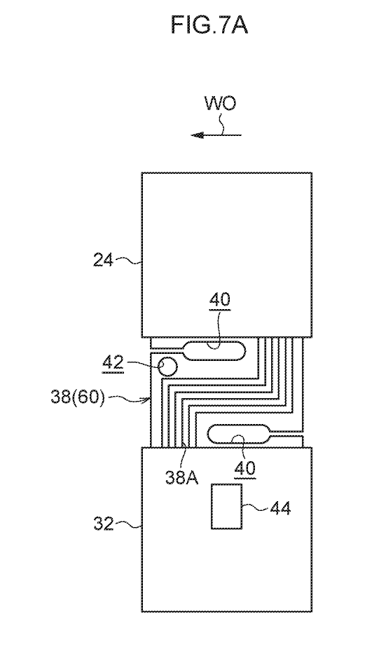

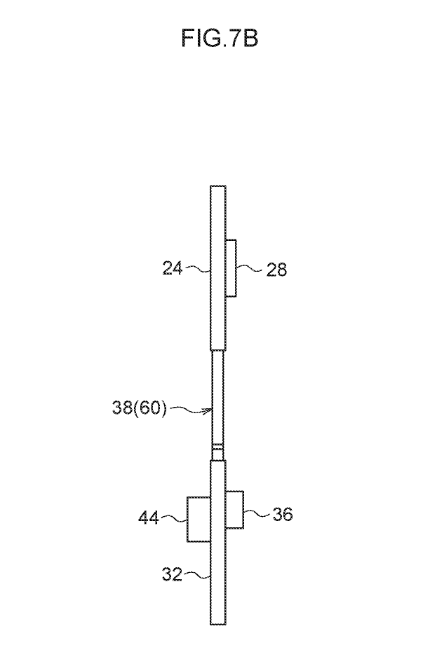

As illustrated in FIG. 7A and FIG. 7B, a control substrate 32-side and other extension width direction-side (other vehicle width direction side) end portion of the flexible substrate 38 is cut along the extension width direction of the flexible substrate 38 from the control substrate 32-side perforation hole 40. A main sensor substrate 24-side and one extension width direction-side (one vehicle width direction side) end portion of the flexible substrate 38 is cut along the extension width direction of the flexible substrate 38 from the main sensor substrate 24-side perforation hole 40.

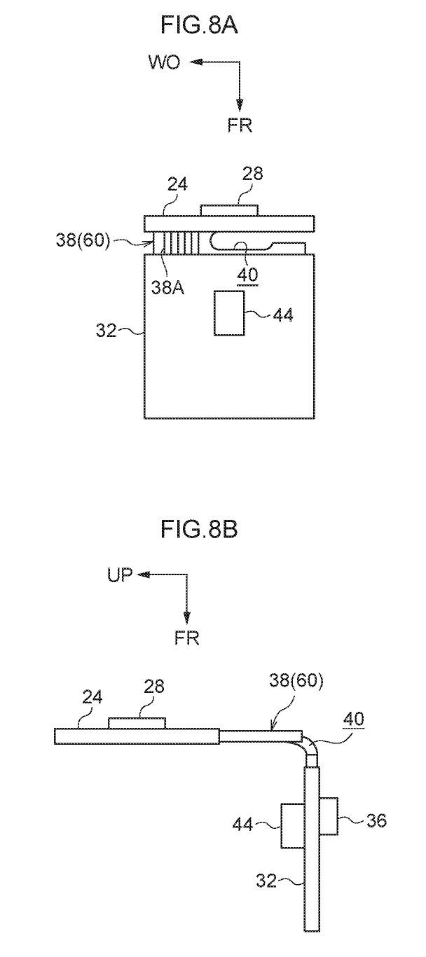

Thus, after the control substrate 32-side end portion of the flexible substrate 38 has curved along the extension direction of the flexible substrate 38 as illustrated in FIG. 8A and FIG. 8B, the extension width direction center portion of the flexible substrate 38 is bent along the extension direction at a portion between the pair of perforation holes 40, such that the front face of the main sensor substrate 24 faces toward the one vehicle width direction side on progression toward the vehicle rear as illustrated in FIG. 9A and FIG. 9B.

The flexible substrate 38 is fixed to the housing case 12 interior by being fixed using screws (not illustrated in the drawings) at the fixing hole 42 (see FIG. 7A).

Note that the present exemplary embodiment exhibits similar operation and advantageous effects to those in the first exemplary embodiment.

Moreover, the extension width direction center portion of the flexible substrate 38 is bent along its extension direction at the portion between the pair of perforation holes 40. Thus, even in cases in which the orientations of the front face of the main sensor substrate 24 and the front face of the control substrate 32 are not disposed so as to be in the same plane, twisting deformation of the flexible substrate 38 about its extension direction can be suppressed, and input of load to the flexible substrate 38 about its extension direction can be suppressed.

The flexible substrate 38 is fixed to the housing case 12 interior at the fixing hole 42, which is close to the bent portion of the flexible substrate 38. This enables the flexible substrate 38 to be bent in a state in which the flexible substrate 38 has been fixed to the housing case 12 interior at the fixing hole 42. This enables the flexible substrate 38 to be easily bent, and enables the positioning and extension direction accuracy of the bent portion of the flexible substrate 38 to be increased.

The perforation holes 40 are formed penetrating the control substrate 32-side end portion and the main sensor substrate 24-side end portion of the flexible substrate 38. Thus, when cutting the other extension width direction-side end portion on the control substrate 32-side of the flexible substrate 38 and the one extension width direction-side end portion on the main sensor substrate 24-side of the flexible substrate 38, the flexible substrate 38 can be cut starting at the perforation holes 40, enabling the flexible substrate 38 to be easily cut.

This enables common application not only of the main camera 14, the sub camera 16, and the control substrate 32, but also of the flexible substrate 38, to the imaging device 10 of the first exemplary embodiment and to the imaging device 60 of the present exemplary embodiment, which have different orientations for the optical axis of the main lens 20 of the main camera 14. This enables costs to be reduced.

Furthermore, by changing at least one of the position, the extension direction, or the bend angle of the bent portion of the flexible substrate 38, at least one of the position or orientation of the front face of the main sensor substrate 24 can be changed, enabling at least one of the position or orientation of the optical axis of the main lens 20 of the main camera 14 to be changed. This enables the imaging device 60 to be applied to plural types of vehicle that differ in at least one of the position or orientation of the optical axis of the main lens 20 of the main camera 14, enabling the number of types of vehicle to which the imaging device 60 can be applied to be increased.

Note that in the present exemplary embodiment, the flexible substrate 38 is bent between the pair of perforation holes 40. However, the flexible substrate 38 may be bent between a pair of cut portions, or between a cut portion and an perforation hole 40.

In the first exemplary embodiment and the second exemplary embodiment, the control substrate 32 is attached to the sub camera 16, the control substrate 32 and the sub sensor substrate 26 are electrically connected together by the control connector 36 and the sensor connector 30, and the control substrate 32 and the main sensor substrate 24 are electrically connected together by the flexible substrate 38. However, a configuration may be applied in which the control substrate 32 is attached to the main camera 14, the control substrate 32 and the main sensor substrate 24 are electrically connected together by the control connector 36 and the sensor connector 30, and the control substrate 32 and the sub sensor substrate 26 are electrically connected together by the flexible substrate 38.

In the first exemplary embodiment and the second exemplary embodiment, the flexible substrate 38 cannot disconnect the electrical connection between the control substrate 32 and the main sensor substrate 24. However, the flexible substrate 38 may be configured so as to be able to disconnect the electrical connection between the control substrate 32 and the main sensor substrate 24.

In the first exemplary embodiment and the second exemplary embodiment, the control substrate 32 and the main sensor substrate 24 are electrically connected together by the flexible substrate 38. However, the main sensor substrate 24 and the sub sensor substrate 26 may be electrically connected together by the flexible substrate 38, or the control substrate 32 and the sub sensor substrate 26 may be electrically connected together by the flexible substrate 38.

In the first exemplary embodiment and the second exemplary embodiment, two cameras (the main camera 14 and the sub camera 16) are provided to the imaging device 10, 60. However, three or more cameras (main cameras 14 and sub cameras 16) may be provided to the imaging device 10, 60. In such cases, the number of control substrates 32 may be fewer than the number of cameras.

In the first exemplary embodiment and the second exemplary embodiment, the cameras (the main camera 14 and the sub camera 16) are capable of capturing images looking toward the vehicle rear and downward respectively. However, cameras may be configured so as to be capable of capturing images in other directions (such as looking toward the vehicle front, upward, the one vehicle width direction side, or the other vehicle width direction side).

In the first exemplary embodiment and the second exemplary embodiment, the imaging device 10, 60 is mounted to a vehicle side door. However, the imaging device 10, 60 may be mounted to a section of the vehicle other than a side door.

The entire disclosure of Japanese Patent Application 2016-43502 filed Mar. 7, 2016 is incorporated by reference in the present specification.

### EXPLANATION OF THE REFERENCE NUMERALS

10 imaging device
12 housing case (housing body)
14 main camera (imaging mechanism)
16 sub camera (imaging mechanism)
24 main sensor substrate (operating device)
26 sub sensor substrate (operating device)
32 control substrate (control device)
38 flexible substrate (connecter)
60 imaging device

1. An imaging device comprising:
a plurality of imaging mechanisms that are provided to a vehicle and that are configured to perform imaging; and
a control device that is attached to one of the imaging mechanism, that is electrically connected to another of the imaging mechanism so as to control the other of the imaging mechanism, and that is detachable from the one of the imaging mechanism.

2. The imaging device of claim 1, wherein the control device is attachable to a plurality of the imaging mechanisms.

3. The imaging device of claim 1, wherein the control device controls a plurality of the imaging mechanisms.

4. The imaging device of claim 1, further comprising: an operating device that is provided to each of the plurality of imaging mechanisms and that is electrically operated such that the imaging mechanism performs imaging; and a housing body that houses a plurality of the operating devices and that restricts water ingress into the plurality of the operating devices.

5. The imaging device of claim 1, further comprising a connecter that is flexible and that electrically connects a plurality of the imaging mechanisms.

6. The imaging device of claim 1, further comprising a connecter that is provided with a perforation hole and that electrically connects a plurality of the imaging mechanisms.

7. The imaging device of claim 1, further comprising a connecter that is provided with a cut portion and that electrically connects a plurality of the imaging mechanisms.

8. The imaging device of claim 1, further comprising a connecter that is capable of bending and that electrically connects a plurality of the imaging mechanisms.
